(19) United States
(12) Patent Application Publication
(10) Pub. No.: US 2015/0311492 A1
(43) Pub. Date: Oct. 29, 2015

(54) High Energy Density Charge And Discharge Lithium Battery

(71) Applicant: Fudan University, Shanghai (CN)

(72) Inventors: Xujiong Wang, Shanghai (CN); Quntin Qu, Shanghai (CN); Lili Liu, Shanghai (CN); Yuyang Hou, Shanghai (CN); Yuping Wu, Shanghai (CN)

(21) Appl. No.: 14/408,277

(22) PCT Filed: Jun. 14, 2013
(86) PCT No.: PCT/CN2013/077226

§ 371 Date: May 14, 2015

(30) Foreign Application Priority Data
Jun. 14, 2012 (CN) 201210195152.2

(51) Int. Cl. H01M 2/16; H01M 10/0525; H01M 4/40; H01M 10/0565; H01M 4/38; H01M 10/0562

(52) U.S. Cl. CPC H01M 2/1673; H01M 4/382; H01M 10/0562; H01M 4/405; H01M 10/0565; H01M 10/0525; H01M 2300/0017; H01M 2300/0094

(57) ABSTRACT

The present invention belongs to the electrochemical field. Specifically, the present invention relates to a charge and discharge lithium battery having high energy density. The lithium battery consists of a separator, a cathode, an anode and an electrolyte, wherein the separator is a solid and allows lithium ions to reversibly pass through; the cathode is made of metal lithium or an alloy of lithium; the electrolyte at the cathode side is a common organic electrolyte, a polymer electrolyte, or an ionic liquid electrolyte, or a mixture thereof; the anode is an anode material commonly used in a lithium ion battery; the electrolyte at the anode side is an aqueous solution or a hydrogel electrolyte containing lithium salt. The energy density of the charge and discharge lithium battery is higher than the energy density of the traditional lithium ion battery by at least 30%. The charge and discharge lithium battery having high energy density can be used for storage and discharge of electric power.

### TECHNICAL FIELD

The present invention belongs to the electrochemical field. Specifically, the present invention relates to a charge and discharge lithium battery having high energy density and use of the charge and discharge lithium battery having high energy density.

### TECHNICAL BACKGROUND

Lithium ion battery is characterized by high energy density, large specific power, good cycle performance, no memory effect and no pollution. It has excellent economic benefit, social benefit and strategic significance and thus becomes the most attractive green chemical power source (see Yuping WU, Xiaobing DAI, Junqi MA and Yujiang CHENG, Lithium Ion Battery, Use and Practice, 2004, Chemical Industry Press, Beijing). However, this kind of lithium ion battery has the following shortcomings. (1) Although the cycle performance is improved, the capacity of the battery is far below the reversible capacity of the metal lithium (3800 mAh/g), as graphite (having a theoretical capacity of 372 mAh/g), etc., is used as the cathode material. Meanwhile, the redox potential of graphite (about −2.85V), at which reversible intercalation and de-intercalation of the lithium ions take place, is higher than that of the metal lithium (−3.05V) by about 0.2V. Thus, when graphite is used to form a lithium ion battery, the voltage of the battery is lowered by about 0.2V, which results in low energy density and thereby cannot satisfy the requirement of pure electric vehicle. (2) The lithium ion battery is very sensitive to water, thus harsh assembling environment is required, resulting in high production cost.

Serious safety problem and shortened service life are associated with battery using metal lithium as the cathode material due to the formation of lithium dendrites, which may penetrate the traditional porous separator and result in short circuit of the anode and the cathode. The recently invented rechargeable lithium//air battery (see Tao Zhang et al., Journal of The Electrochemical Society, 2008, Vol. 155, pages A965-A969; Yonggang Wang, Haoshen Zhou, Journal of Power Sources 2010, Vol. 195, pages 358-361) produces LiOH or Li₂O₂ at the air side. LiOH has limited solubility in an aqueous solution (12.5 g/100 g water at ambient temperature). Li₂O₂ can readily block the catalyst layer in the pure organic electrolyte system. Although the metal lithium has a very high energy density (about 13000 Wh/kg), the energy density of the electrode material is very limited, which is only 400 Wh/kg (see J. P. Zheng, et al., J. Electrochem. Soc. 2008, Vol. 155, pages A432-A437). Therefore, the actual capacity is still limited.

### SUMMARY OF INVENTION

The present invention aims to provide a charge and discharge lithium battery having high energy density to solve the problems of low energy density and high production cost of the lithium ion battery, poor safety of the battery having metal lithium as the cathode material, and limited capacity of the metal lithium//air battery.

The charge and discharge lithium battery having high energy density of the present invention consists of a separator, a cathode, an anode and an electrolyte, wherein
(1) The separator is a solid and allows lithium ions to reversibly pass through;
(2) The cathode is made of metal lithium or an alloy of lithium;
(3) The electrolyte at the cathode side is a common organic electrolyte, a polymer electrolyte, or an ionic liquid electrolyte, or a mixture thereof;
(4) The anode is an anode material commonly used in a lithium ion battery;
(5) The electrolyte at the anode side is an aqueous solution or a hydrogel electrolyte containing lithium salt.

In the present invention, the separator is a lithium-containing inorganic oxide, lithium-containing sulphide, or an all solid-state polymer electrolyte containing lithium salt, or a mixture thereof; the lithium-containing inorganic oxide is a ternary system, such as LiTi₂(PO₄)₃, Li₄Ge_{0.5}V_{0.5}O₄, Li₄SiO₄, LiZr(PO₄)₂, LiB₂(PO₄)₃ Or Li₂O—P₂O₅—B₂O₃, or a doped form of these lithium-containing inorganic oxides; the lithium-containing sulfide is a ternary system, such as Li₂S—GeS₂—SiS₂ or Li₃PO₄—GeS₂—SiS₂, or a doped form of these lithium-containing sulfides; and the all-solid state polymer electrolyte containing lithium salt is poly(ethylene oxide) containing lithium salt, polyvinylidene fluorine containing lithium salt, siloxane single ion polymer electrolyte containing lithium salt, or partially or wholly fluorine-substituted alkene single ion polymer electrolyte containing lithium salt.

In the present invention, the alloy of lithium includes an alloy formed from lithium and other metal, or a modified form thereof.

In the present invention, the organic electrolyte is a solution containing lithium salt dissolved in an organic solvent, wherein the lithium salt includes LiClO₄, LiBF₄, LiPF₆, LiBOB or LiTFSI, and the organic solvent includes one or more of acetonitrile, tetrahydrofuran, ethylene carbonate, propylene carbonate, diethyl carbonate, dimethyl carbonate or dimethyl sulfoxide.

The polymer electrolyte includes an all solid-state polymer electrolyte and a gel polymer electrolyte, wherein the all solid-state polymer electrolyte is poly(ethylene oxide) containing lithium salt, polyvinylidene fluorine containing lithium salt, siloxane single ion polymer electrolyte containing lithium salt, or partially or wholly fluorine-substituted alkene single ion polymer electrolyte containing lithium salt, or a mixture thereof; and the gel polymer electrolyte is poly(ethylene oxide), polymer or co-polymer of acrylonitrile, polymer or co-polymer of acrylate, or monopolymer or co-polymer of fluorine-containing alkene, which comprise the above-mentioned organic electrolyte.

In the present invention, the ion liquid electrolyte is an ion liquid containing BF₄⁻ anion, CF₃SO₃⁻ anion, or imidazole cation, pyridine cation, or sulfonium cation.

In the present invention, the common anode material includes LiCoO₂, LiNiO₂, LiMn₂O₄, LiFePO₄ or LiFeSO₄F, or a doped form, a coating compound or a mixture thereof.

In the present invention, the aqueous solution or hydrogel electrolyte containing lithium salt includes an aqueous solution or hydrogel electrolyte containing an inorganic lithium salt or an organic lithium salt; the inorganic lithium salt includes halide, sulphide, sulphate, nitrate or carbonate of metal lithium; the organic lithium salt includes lithium carboxylate or lithium sulfonate.

The structure of the charge and discharge battery having high energy density of the present invention is shown in FIG. 1. The voltage of the charge and discharge battery having high energy density is higher than the common lithium ion battery by 0.2V, as it uses metal lithium as the cathode. Meanwhile, the reversible capacity of metal lithium is higher than graphite, and the anode contains lithium, thus, the cathode requires less lithium. Since a solid that allows lithium ion reversibly passes through is used as a separator and lithium dendrites cannot pass through the separator, the battery has an excellent safety property. At the same time, an organic electrolyte, polymer electrolyte or ion liquid electrolyte is present at the cathode side, resulting in that the metal lithium is very stable and reversible dissolution and electrodeposition reaction can take place. And, at the anode side, the anode material commonly used in the lithium ion battery is also very stable in the aqueous system (see Y. P. Wu et al., symposia of CIMTEC 2010 5^{th} Forum on New Materials, Jun. 13-18, 2010, Italy, FD-1:IL12), reversible intercalation and de-intercalation of the lithium ions can take place, and the heavy current has an excellent performance, thus the battery has a favorable stability. Additionally, the solid separator can prevent water from moving to the cathode and prevent electrolyte or solvent at the cathode side from moving to the anode side, thus the charge and discharge lithium battery has high energy density and excellent stability and cycle performance.

The present invention also provides use of the charge and discharge lithium battery having high energy density in storage and discharge of electric power.

The charge and discharge lithium battery prepared by the present invention has high energy density and very favourable stability and cycle performance.

### BRIEF DESCRIPTION OF THE DRAWINGS

FIG. 1 shows the structural representation of the charge and discharge lithium battery having high energy density prepared by the present invention.

FIG. 2 shows (a) the first charge and discharge curve and (b) the cycle curve of the first 30 cycles of Example 3.

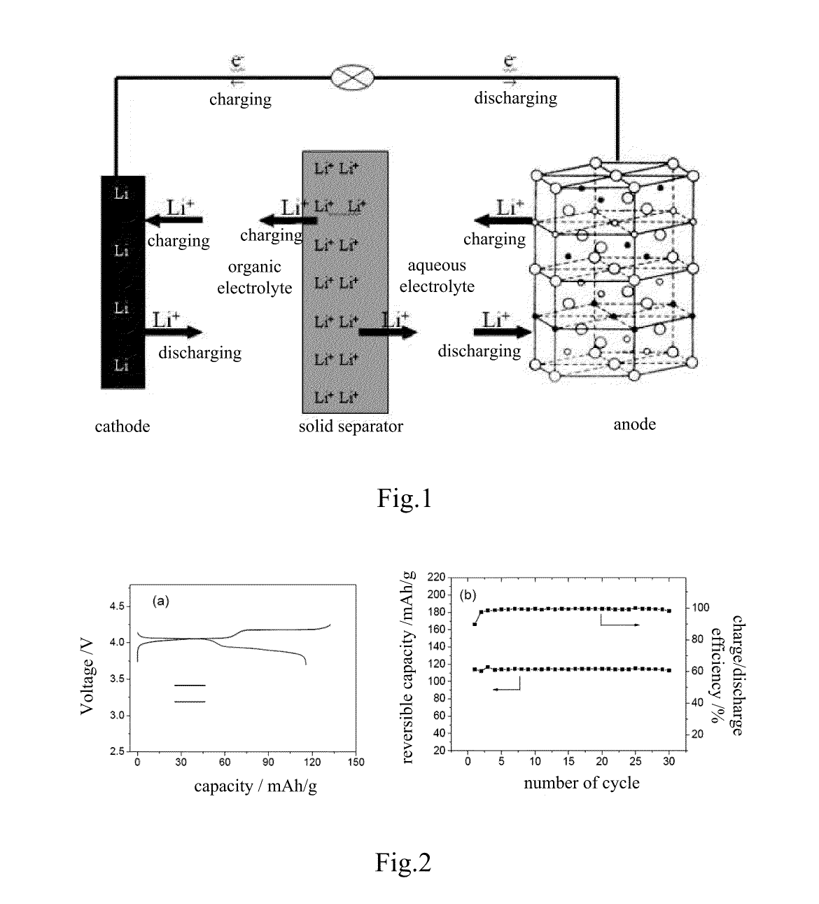

### BEST MODE FOR CARRYING OUT THE INVENTION

Detailed description will be set forth below in connection with the Examples and Comparative Examples. However, the protection scope of the invention is not limited to these Examples.

### COMPARATIVE EXAMPLE 1

Graphite of high capacity (372 mAh/g) was used as an active ingredient of the cathode. LiCoO₂ having a reversible capacity of 145 mAh/g was used as an active ingredient of the anode. Super-P was used as a conduction agent. Polyvinylidene fluorine was used as a binder. N-methyl-pyrrolidone was used as a solvent. The components were mixed to form a homogenous paste and then coated on the copper foil and aluminium foil respectively to prepare the pole pieces of the cathode and the anode. Since the capacity of the cathode in the battery is slightly excessive, the capacity of the cathode that is actually utilized is 350 mAh/g. The pole pieces of the cathode and the anode were dried under vacuum. A porous alkene membrane available from Celgard (Model 2400) was used as a separator and wound into a core of the lithium ion battery and then placed into a quadrangular aluminium shell. The shell was sealed by laser and dried under vacuum. Electrolyte (LB315, purchased from Zhangjiagang Guotai Huarong) was introduced at the charge port. The battery was subjected to formation and grading and then sealed by putting a steel ball into the charge port to produce a lithium ion battery using graphite as the cathode and LiCoO₂ as the anode. The battery was tested by using 1 C current. Specifically, 1 C constant current was used for charge and constant voltage was used after charging to 4.2V and the charge procedure was finished after the current was 0.1 C. The discharge current was 1 C and the final voltage was 3.0V. The average discharge voltage was obtained based on the test result, and the energy density was obtained according to the weight of the active ingredient in the electrolyte. For convenience, these data were summarized in Table 1.

### EXAMPLE 1

A platinum sheet laminated with 0.1 mg/m² lithium-gallium alloy was used as the cathode. LiCoO₂ having a reversible capacity of 145 mAh/g, used as an active ingredient of the anode, and the conduction agent, binder and solvent used in Comparative Example 1 were mixed to form a homogenous paste and then coated on a stainless steel net to prepare a pole piece of anode. A ceramic membrane having a component of 19.75Li₂O-6.17Al₂O₃-37.04GeO₂-37.04P₂O₅ (a lithium-containing inorganic oxide) was used as a separator. An organic electrolyte (LB315, purchased from Zhangjiagang Guotai Huarong) was used at the cathode side and 1 mol/l LiNO₃ solution was used at the anode side. After sealing, a charge and discharge lithium battery having LiCoO₂ as the anode and lithium-gallium alloy as the cathode was produced. Test was performed by using 0.1 mA/cm². Charge was performed by using a constant current, 0.1 mA/cm², until the voltage reached 4.25V. Discharge current was 0.1 mA/cm² and the final voltage was 3.7V. The average discharge voltage was obtained based on the test result, and the energy density was obtained according to the weight of the active ingredient in the electrolyte. For convenience, these data were summarized in Table 1.

### COMPARATIVE EXAMPLE 2

The preparation conditions were the same as Comparative Example 1, except that the active ingredient of the anode was changed to LiNiO₂ having a reversible capacity of 180 mAh/g. A lithium ion battery having graphite as the cathode and LiNiO₂ as the anode was thus produced. The test conditions were also identical to Comparative Example 1. The average discharge voltage was obtained based on the test result, and the energy density was obtained according to the weight of the active ingredient in the electrolyte. For convenience, these data were summarized in Table 1.

### EXAMPLE 2

Aluminium foil having LiAl alloy formed on its surface was used as the cathode. LiNiO₂ having a reversible capacity of 180 mAh/g, used as an active ingredient of the anode, and the conduction agent, binder and solvent used in Comparative Example 1 were mixed to form a homogenous paste and then coated on a stainless steel net to prepare a pole piece of anode. A ceramic membrane having a component of Li_{1.5}Al_{0.5}Ge_{1.5}P₃S₁₂ (a lithium-containing sulfide) was used as a separator. An organic electrolyte (0.8 mol/l LiBOB electrolyte dissolved in a mixed solvent of ethylene carbonate and methyl ethyl carbonate in a mass ratio of 1:1) was used at the cathode side and 1 mol/l CH₃COOLi gel having 1 wt % polyvinyl alcohol dissolved therein was used at the anode side. After sealing, a charge and discharge lithium battery having LiNiO₂ as the anode and lithium-aluminium alloy as the cathode was produced. Test was performed as in Example 1. The average discharge voltage was obtained based on the test result, and the energy density was obtained according to the weight of the active ingredient in the electrolyte. For convenience, these data were summarized in Table 1.

### COMPARATIVE EXAMPLE 3

The preparation conditions were the same as Comparative Example 1, except that the active ingredient of the anode was changed to LiMn₂O₄ having a reversible capacity of 120 mAh/g. A lithium ion battery having graphite as the cathode and LiMn₂O₄ as the anode was thus produced. The test conditions were also identical to Comparative Example 1. The average discharge voltage was obtained based on the test result, and the energy density was obtained according to the weight of the active ingredient in the electrolyte. For convenience, these data were summarized in Table 1.

### EXAMPLE 3

Metal lithium was used as the cathode. LiMn₂O₄ having a reversible capacity of 115 mAh/g, used as an active ingredient of the anode, and the conduction agent, binder and solvent used in Comparative Example 1 were mixed to form a homogenous paste and then coated on a stainless steel net to prepare a pole piece of anode. A ceramic membrane having a component of 0.75Li₂O-0.3Al₂O₃-0.2SiO₂-0.4P₂O₅-0.1TiO₂ (a lithium-containing inorganic oxide) was used as a separator. A gel polymer electrolyte consisting of a composite membrane PVDF/PMMA/PVDF formed by porous polyvinylidene fluorine (PVDF) and polymethyl methacrylate (PMMA) and an organic electrolyte (LB315, purchased from Zhangjiagang Guotai Huarong) was used at the cathode side, and 0.5 mol/l Li₂SO₄ aqueous electrolyte was used at the anode side. After sealing, a charge and discharge lithium battery having LiMn₂O₄ as the anode and metal lithium as the cathode was produced. Test was performed as in Example 1. The average discharge voltage was obtained based on the test result, and the energy density was obtained according to the weight of the active ingredient in the electrolyte. For convenience, these data were summarized in Table 1. The first charge and discharge curve was shown in FIG. 2(a) and the cycle curve of the first 30 cycles was shown in FIG. 2(b).

### COMPARATIVE EXAMPLE 4

The preparation conditions were the same as Comparative Example 1, except that the active ingredient of the anode was changed to LiFePO₄ having a reversible capacity of 140 mAh/g. A lithium ion battery having graphite as the cathode and LiFePO₄ as the anode was thus produced. The battery was tested by using 1 C current. Specifically, 1 C constant current was used for charge and constant voltage was used after charging to 3.8V and the charge procedure was finished after the current was 0.1 C. The discharge current was 1 C and the final voltage was 2.0V. The average discharge voltage was obtained based on the test result, and the energy density was obtained according to the weight of the active ingredient in the electrolyte. For convenience, these data were summarized in Table 1.

### EXAMPLE 4

A nickel net having metal lithium laminated thereon was used as the cathode. LiFePO₄ having a reversible capacity of 140 mAh/g, used as the active ingredient of the anode, and the conduction agent, binder and solvent used in Comparative Example 1 were mixed to form a homogenous paste and then coated on a stainless steel net to prepare a pole piece of anode. An all solid-state membrane (an all solid-state polymer electrolyte containing lithium salt) formed by 8 wt % LiTFSI, 5wt % Nafion 117 (a product from DuPont USA, containing lithium salt) and 83 wt % PEO was used as a separator. A gel polymer electrolyte (the organic electrolyte (LB315, purchased from Zhangjiagang Guotai Huarong) with 3 wt % polymethyl methacrylate dissolved therein) was used at the cathode side, and a 2 mol/l LiNO₃ aqueous solution with 1 wt % lithium polyacrylate dissolved therein was used at the anode side. After sealing, a charge and discharge lithium battery having LiFePO₄ as the anode and metal lithium as the cathode was produced. Test was performed by using 0.1 mA/cm². Charge was performed by using a constant current, 0.1 mA/cm², until the voltage reached 3.8V. Discharge current was 0.1 mA/cm² and the final voltage was 2.5V. The average discharge voltage was obtained based on the test result, and the energy density was obtained according to the weight of the active ingredient in the electrolyte. For convenience, these data were summarized in Table 1.

TABLE 1
The energy density of the batteries prepared in the
above Comparative Examples and Examples (based on the
mass of the active ingredients of the electrode)

| | | | Average | Energy |
|---|---|---|---|---|
| | | | discharge | density |
| Example | Cathode | Anode | voltage (V) | (Wh/kg) |
| Comparative | Graphite | LiCoO₂ | 3.7 | 379 |
| Example 1 | | | | |
| Example 1 | LiGa* | LiCoO₂ | 3.8 | 530 |
| Comparative | Graphite | LiNiO₂ | 3.5 | 416 |
| Example 2 | | | | |
| Example 2 | LiAl* | LiNiO₂ | 3.6 | 618 |
| Comparative | Graphite | LiMn₂O₄ | 3.8 | 339 |
| Example 3 | | | | |
| Example 3 | Metal lithium* | LiMn₂O₄ | 4.0 | 446 |
| Comparative | Graphite | LiFePO₄ | 3.2 | 320 |
| Example 4 | | | | |
| Example 4 | Metal lithium* | LiFePO₄ | 3.4 | 459 |

*The cathode material was calculated based on 1 mol of lithium.

According to the data in Table 1, the energy density of the batteries prepared in the Examples is higher than the energy density of the batteries prepared in Comparative Examples using the same anode by at least 30%.

1. A charge and discharge lithium battery having high energy density consisting of a separator, a cathode, an anode and an electrolyte, wherein
(1) The separator is a solid and allows lithium ions to reversibly pass through;
(2) The cathode is made of metal lithium or an alloy of lithium;
(3) The electrolyte at the cathode side is a common organic electrolyte, a polymer electrolyte, or an ionic liquid electrolyte, or a mixture thereof;
(4) The anode is an anode material commonly used in a lithium ion battery;
(5) The electrolyte at the anode side is an aqueous solution or a hydrogel electrolyte containing lithium salt;
wherein the separator is a lithium-containing inorganic oxide, lithium-containing sulphide, or an all solid-state polymer electrolyte containing lithium salt, or a mixture thereof.

2. The charge and discharge lithium battery having high energy density according to claim 1, wherein the lithium-containing inorganic oxide is a ternary system selected from the group consisting of LiTi₂(PO₄)₃, Li₄Ge_{0.5}V_{0.5}O₄, Li₄SiO₄, LiZr(PO₄)₂, LiB₂(PO₄)₃ or Li₂O—P₂O₅—B₂O₃, or a doped form of these lithium-containing inorganic oxides; the lithium-containing sulfide is a ternary system selected from the group consisting of Li₂S—GeS₂—SiS₂ or Li₃PO₄—GeS₂—SiS₂, or a doped form of these lithium-containing sulfides; and the all-solid state polymer electrolyte containing lithium salt is poly(ethylene oxide) containing lithium salt, polyvinylidene fluorine containing lithium salt, siloxane single ion polymer electrolyte containing lithium salt, or partially or wholly fluorine-substituted alkene single ion polymer electrolyte containing lithium salt.

3. The charge and discharge lithium battery having high energy density according to claim 1, wherein the organic electrolyte is a solution containing lithium salt dissolved in an organic solvent, wherein the lithium salt includes LiClO₄, LiBF₄, LiPF₆, LiBOB or LiTFSI, and the organic solvent includes one or more of acetonitrile, tetrahydrofuran, ethylene carbonate, propylene carbonate, diethyl carbonate, dimethyl carbonate or dimethyl sulfoxide.

4. The charge and discharge lithium battery having high energy density according to claim 1, wherein the polymer electrolyte is an all solid-state polymer electrolyte and a gel polymer electrolyte, wherein the all solid-state polymer electrolyte is poly(ethylene oxide) containing lithium salt, polyvinylidene fluorine containing lithium salt, siloxane single ion polymer electrolyte containing lithium salt, or partially or wholly fluorine-substituted alkene single ion polymer electrolyte containing lithium salt, or a mixture thereof; and the gel polymer electrolyte is poly(ethylene oxide), polymer or co-polymer of acrylonitrile, polymer or co-polymer of acrylate, or monopolymer or co-polymer of fluorine-containing alkene, which comprise the above-mentioned organic electrolyte.

5. The charge and discharge lithium battery having high energy density according to claim 1, wherein the ion liquid electrolyte is an ion liquid containing BF₄⁻ anion, CF₃SO₃⁻ anion, or imidazole cation, pyridine cation, or sulfonium cation.

6. The charge and discharge lithium battery having high energy density according to claim 1, wherein the anode material is LiCoO₂, LiNiO₂, LiMn₂O₄, LiFePO₄ or LiFeSO₄F, or a doped form, a coating compound or a mixture thereof.

7. The charge and discharge lithium battery having high energy density according to claim 1, wherein the aqueous solution or hydrogel electrolyte containing lithium salt is an aqueous solution or hydrogel electrolyte with inorganic lithium salt or organic lithium salt dissolved therein; the inorganic lithium salt is halide, sulphide, sulphate, nitrate or carbonate of metal lithium; and the organic lithium salt is lithium carboxylate or lithium sulfonate.

8. Use of the charge and discharge lithium battery having high energy density according to any of claims 1-7 in storage and discharge of electric power.
